(19) United States
(12) Patent Application Publication
(10) Pub. No.: US 2016/0367056 A1
(43) Pub. Date: Dec. 22, 2016

(54) SYSTEM FOR SUPPLYING A FOOD SUPPLEMENT TO A COFFEE OR BEVERAGE CONTAINER

(71) Applicant: Robert Otto Wiesemann, III, Chicago, IL (US)

(72) Inventor: Robert Otto Wiesemann, III, Chicago, IL (US)

(21) Appl. No.: 14/742,097

(22) Filed: Jun. 17, 2015

(51) Int. Cl. A47G 23/02; A47G 19/22

(52) U.S. Cl. CPC A47G 23/0216; A47G 19/2227; A23L 1/0005; A23V 2002/00

(57) ABSTRACT

A cup and breath freshening device is provided which includes a cup having a bottom and sidewalls, the sidewalls extending upwardly from the bottom and being sealed about the periphery. A sleeve is circumferentially disposed around a portion of the sidewalls. The sleeve has one or more pouches affixed to the sleeve. A breath freshener or other edible product may be insertable into and retained by the pouches. In one embodiment the pouches are sealed to the paperboard sleeve. In an alternative embodiment one or more pouches may be integrally formed in the sleeve for retention of the edible food product. In a further embodiment a patch having 1 or more pouches for retaining a food product may be affixed to a beverage container.

### FIELD OF THE INVENTION

The present invention relates to breath freshening devices and more particularly pertains to a cup and breath freshening combination device for providing an edible breath freshener with a coffee and/or beverage cup or container.

### DESCRIPTION OF THE PRIOR ART

A wide variety of breath freshening devices are known in the prior art. Examples include U.S. Pat. No. 5,024,014; U.S. Pat. No. 5,137,210; U.S. Pat. No. 4,923,702; U.S. Pat. No. 3,278,014; U.S. Pat. No. 2,794,545; and U.S. Des. Pat. No. 372,398, U.S. Pat. No. 6,484,873 and U.S. Pub. No. US2004/0149598.

While these devices and patents disclose a variety of ways of providing a breath freshener with a cup of liquid such as coffee, they require a customized lid or an adhesive for attaching the breath freshener to the cup.

Accordingly, the present invention provides an apparatus and method for providing a breath freshener to a wide variety of beverage containers in a simple inexpensive and colorful system which allows substitution of a variety of edible breath fresheners and the ability to display selected advertising as desired.

### SUMMARY OF THE INVENTION

The present invention provides a system for dispensing breath fresheners including a tapered paperboard sleeve adapted for reception of a paperboard or Styrofoam cup, aluminum can or any beverage container. On the sleeve or patch are one or more slotted expandable tapered pouches. The pouches are built into the sleeve or affixed to the sleeve or beverage container by conventional adhesive such as hot melt. To accomplish these objectives the present invention includes a paperboard cup or any beverage container. The tapered paperboard sleeve of the present invention is adapted for telescopic reception of a wide variety of paperboard cups. For example tall coffee cups served by Starbucks comes in four sizes short, an 8 ounce cup, tall, a 12 ounce cup, Grande, a 16 ounce cup and Venti, a 20 ounce cup. The Venti is a 24 ounce cup for cold drinks. The tall Starbucks cup has an outside diameter of 3 5/16th inches at its top, height of 4½ inches and an outside diameter of 2¼ inches at its bottom. A conventional cardboard sleeve, as used in Starbucks is 1⅞ inch wide and approximately 2½ inches in diameter at its top and 2¼ inches in diameter at its bottom. In a preferred embodiment the sleeve is approximately 7½ inches long before it is sealed to form a truncated cone which appears to be trapezoid from its side.

Although one tapered pouch may be utilized, in a preferred embodiment two are utilized. Each has a height of approximately 1¼ inches and a width of approximately 1/16th inch. The tapered pouch when opened has a top opening of approximately ½ inch at its top, and a bottom surface which is 3/16 of an inch. The one or more pouches are adapted for reception of a standard piece of chewing gum or smaller pieces thereof. Alternatively a Lifesaver or other individually wrapped mints or other unwrapped mints such as Altoids or Mentos mints may be dispensed. These come in a wide variety of flavors. Additionally, the pouches may be used to hold sweetener, sugar or creamer packets.

In a preferred embodiment the sleeve is constructed of corrugated paperboard having a thickness of 20 mils plus or minus 5 mils and the pouches are constructed of paperboard having a thickness of 20 mils plus or minus 10 mils.

One of the advantages of the present inventions is that both the cup and lid are of conventional design. The cup has a bottom and sidewalls extending upwardly from the bottom and sealed about the periphery of the bottom thereto so as to be waterproof. The sleeve is circumferentially disposed about a portion of the sidewalls of the cup and the pouches are affixed or built into the sleeve, with a breath freshener insertable into and retained by the pouches.

In one embodiment, the pouches may have a pressure sensitive adhesive thereon so that they can be affixed to the sleeve or any beverage container after preparation of the coffee and filling of the cup. The pouches are preferably tapered and expandable from the sidewalls of the cup so as to allow insertion of the breath freshener. While the present invention is designed primarily for insertion of a breath freshener, in an alternative embodiment the pouches may be of a larger size and may be utilized for providing a small food product such as a bite size portion of cake or a cookie.

The present invention further includes a method of providing a disposable cup and breath freshener which includes the cup having a bottom and sidewalls sealingly affixed to the bottom about the periphery of the bottom, a paperboard sleeve size constructed and arranged for reception of the paperboard cup and one or more pouches on the paperboard sleeve sized constructed and arranged for reception of the breath freshener. The method includes the steps of inserting the cup into the sleeve and inserting the breath freshener into the one or more pouches.

In one embodiment the paperboard sleeve may have the one or more pouches integrally formed therein so as to reduce costs and to provide a receptacle for the breath freshener. The sleeve and cup are preferably constructed of either solid bleach sulfate paper or corrugated paper having a thickness of 0.20 mils plus or minus 0.10 mils.

### BRIEF DESCRIPTION OF THE DRAWINGS

It should be understood that the invention is not limited to the embodiments shown therein. The invention is capable of other embodiments and of being practiced and carried out in various ways. Also it is to be understood that the description employed herein is for purposes of explanation and should not be regarded as limiting.

FIG. 1 of the drawings is a front elevation view of the system for dispensing breath fresheners of the present invention including a tapered paperboard sleeve having a paperboard cup telescopically inserted therein and having a pair of tapered expandable pouches affixed onto said sleeve.

FIG. 2 of the drawings is a front elevation view of the sleeve of FIG. 1.

FIG. 3 of the drawings is a front elevation view of the sleeve of FIG. 1 having its ends disassembled and displayed on a flat surface showing in particular its arched configuration.

FIG. 4 of the drawings has the front elevational view of the sleeve of FIG. 1 showing in particular the tapered expandable pouches affixed thereto.

FIG. 5 of the drawings is a bottom view of the pouches of FIG. 4.

FIG. 6 of the drawings is a top view of the pouches of FIG. 4.

FIG. 7. of the drawings is a side cutaway view of the pouches of FIG. 4 shown affixed to the sleeve of FIG. 1.

FIG. 8. of the drawings is a front perspective view of an alternate embodiment of the sleeve of FIGS. 1 through 3 showing a tapered pocket integrally formed in the sleeve.

FIG. 9 of the drawings is an additional alternate embodiment of the sleeve of FIG. 1 showing in particular the tapered pocket being integrally formed in the sleeve and having an opening at the top which tapers down to a bottom portion which is collinear with a bottom portion of the left and right sides of the sleeve.

FIG. 10 of the drawings is a front perspective view of the cup and breath freshening device of the present invention shown in FIGS. 1 and 2.

FIG. 11 of the drawings is a front view of an alternative embodiment of the dispensing device of FIG. 1 showing in particular a pair of tapered expandable pouches which may be affixed to a beverage container for retaining food a supplement such as mints, candy or gum.

FIG. 12 of the drawings is rear view of the dispensing device of FIG. 11.

FIG. 13 of the drawings is a side view of one of the pouches shown in FIGS. 11 and 12.

FIG. 14 of the drawings is a top view of the dispensing device of FIGS. 11 to 14.

FIG. 15 of the drawings is a bottom view of the dispensing vice of FIG. 11 to 14.

FIG. 16 of the drawings is a front perspective view of a supplemental beverage container.

### DETAILED DESCRIPTION OF THE PREFERRED EMBODIMENT

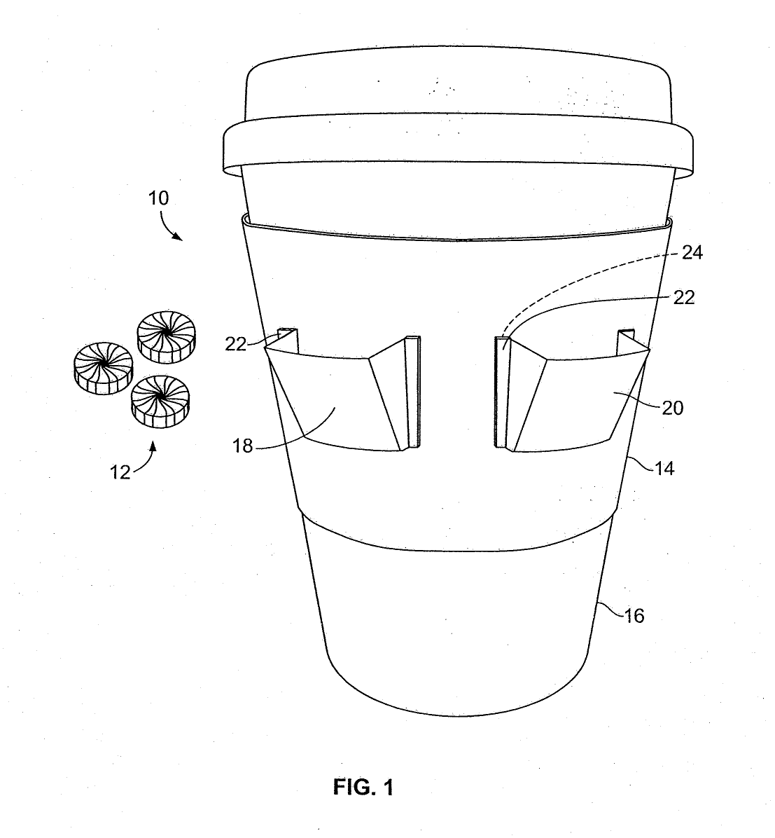

As best seen in FIG. 1 of the drawings, in one embodiment, a system 10 for dispensing breath fresheners 12 is disclosed. The system includes a tapered paperboard sleeve 14 adapted for reception of a paperboard cup 16. The paperboard sleeve includes one or more slotted expandable tapered pouches 18 and 20 and a mechanism 22 for affixing the tapered pouches to the paperboard sleeve. In a preferred embodiment the tapered pouches are adhesively retained to the paperboard sleeve by adhesive 24. Adhesive 24 may comprise hot melt or a wide variety of conventional liquid adhesives which are FDA approved for contact with food containers.

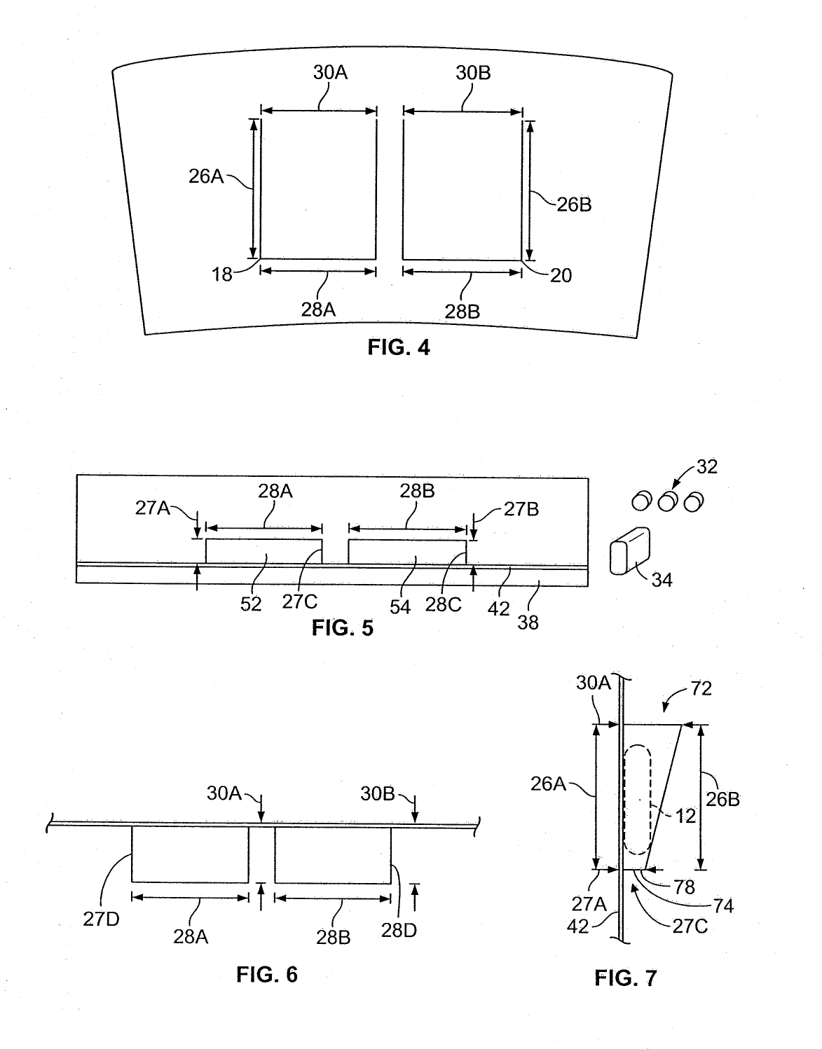

In a preferred embodiment as seen in FIGS. 4, 5, 6, and 7 the tapered pouches are 1¼ inches high plus or minus ¼ of an inch as shown by numbers 26a and 26b. They are 3/16ths inches from front to back at the bottom 27c and 28c as shown by numbers 27a and 27b. They are 1 and 1/16 inches wide, as shown at 28a and 28b and ½ inch deep from front to back at their top, 27d and 28d (FIG. 6) as shown in numbers 30a and 30b. In a preferred embodiment the breath fresheners comprise breath mints 32 or chewing gum 34 (seen in FIG. 5). Alternatively, the pouches may be used to hold sweetener, sugar or creamer packets. As seen in FIGS. 1-7 in a preferred embodiment there are two or more tapered expandable pouches 18 and 20 on tapered paperboard sleeve 14. Paperboard sleeve 14 preferably is constructed of corrugated paperboard having a thickness of 20 mils plus or minus 10 mils. Tapered expandable pouches 18 and 20 may also be constructed of paperboard having a thickness of 20 mils plus or minus 10 mils, or may be constructed of corrugated paperboard, as desired.

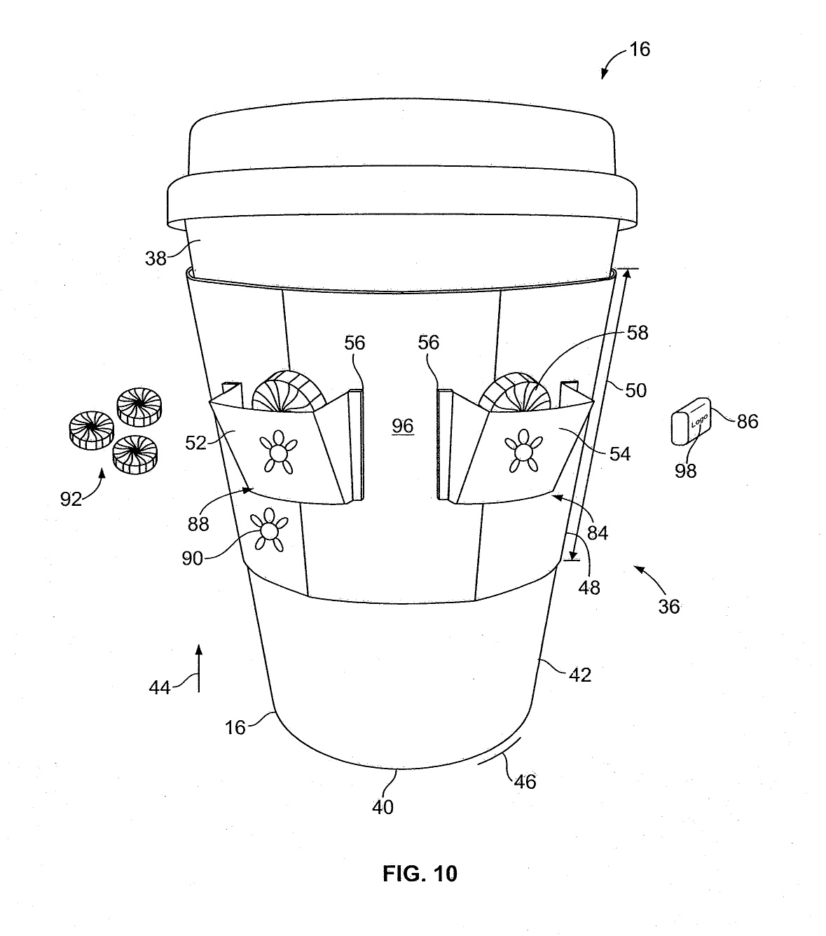

As seen in FIG. 10 the present invention may also be described as a cup and breath freshener device 36 which includes a cup 38 having a bottom 40 and sidewalls 42, the sidewalls extending upwardly in an upward direction 44 from the bottom 40 and being sealed about the periphery 46 of the bottom 40 by conventional sealing means such as FDA approved adhesives or a coating on the sidewalls or bottom which may be heat sealed to the sidewalls and bottom. A sleeve 48 is circumferentially disposed around a portion 50 of the sidewalls and one or more pouches 52 and 54 are affixed to the sleeve 48 by heat sealing a plastic coating on the pouch 56 or by FDA approved adhesives or hot melt. A breath freshener 58 is insertable into and retained by the pouches 52 and 54.

As best seen in FIGS. 5, 6, and 7 the pouches 52 and 54 are tapered from the top 27C (FIG. 6) to the bottom 28C (FIG. 5) and expandable from the sidewalls of 42 of the cup 38. A wide variety of breath fresheners may be utilized including mints such as Altoid brand or Mentos brand mints or chewing gum such a Wrigley Spearmint gum. Alternately candy may be inserted into the pouches such as a small chocolate, or even a cookie or piece of cake, or packets of sugar, sweetener or creamer.

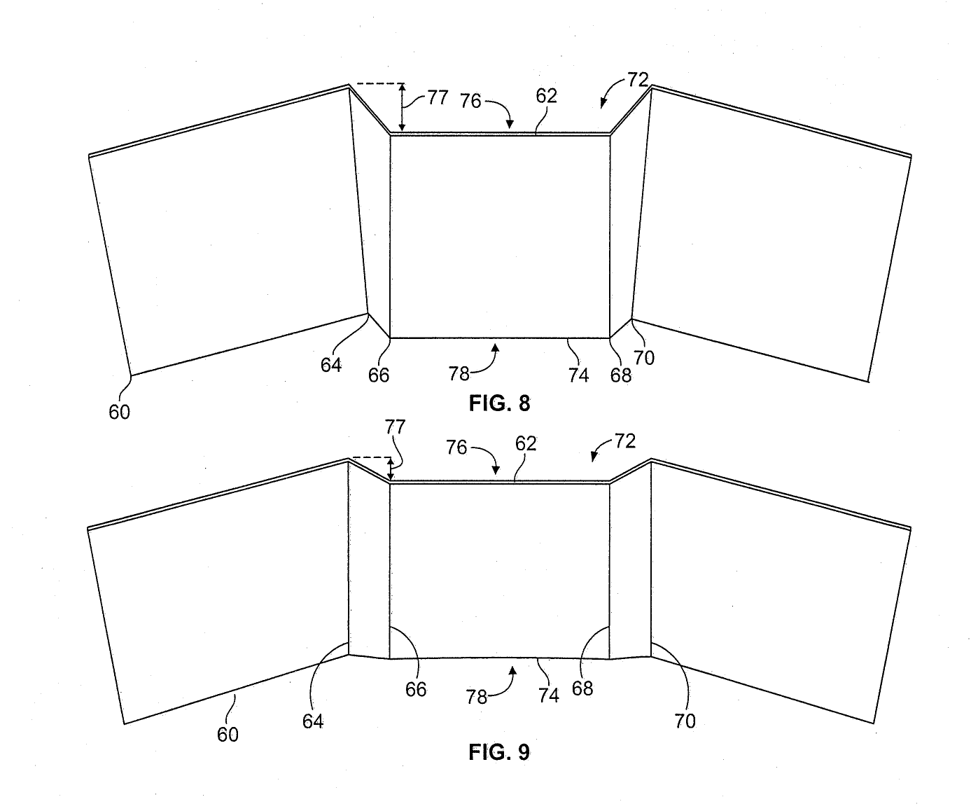

As seen in FIGS. 8 and 9 of the drawings, sleeve 60 may have one or more integrally formed tapered pouches 62 integrally formed therein. This is accomplished by die cutting sleeve 60 and having a plurality of score lines 64, 66, 68 and 70 so as to form a balcony or pocket 72 adapted for reception of a breath freshener or other products. In the embodiment shown in FIG. 9, the balcony or pocket does not have a bottom 74, but the pocket 72 is small enough to allow insertion and retention of the breath freshener or other food product. In the embodiment shown in FIG. 8, the pocket 72 tapers from the top 76 to the bottom 78 so that the pocket 72 has an opening at the top 77 for reception of the breath freshener or other food product and at the bottom is co-linear with the left and right bottom edges of sleeve 60. As a result the pocket tapers inwardly from the top 76 to the bottom 78. When a cup is inserted into the sleeve 60, the bottom of the pocket 78 abuts against the sidewall 42 of the cup. As a result a breath freshener or mint or other food product may be retained within the pocket 72. It should be noted in this regard that pocket 72 may also be called a pouch.

As best seen in FIG. 10, tapered pouches 52 and 54 in a preferred embodiment are 1¼ inches high plus or minus ¼ by 3/16ths inches at their base plus or minus 1/16th inches and 1½ inch plus or minus ⅛ at their top opening. Further, in a preferred embodiment the sleeve 48 is constructed of corrugated paperboard having a thickness of 20 mils plus or minus 5 mils. The tapered pouches 52 and 54 seen in FIG. 10 may be constructed of paperboard having a thickness of 20 mils plus or minus 10 mils. Alternatively, a plastic pouch can be adhesively attached to the sidewall of the cup containing the breath mint or breath freshener.

In an alternative embodiment of the invention, the breath freshener may have a pressure sensitive adhesive or gum affixed thereto so that the breath mint or freshener 12 can simply be adhesively attached to the sidewall of the cup 38.

As further seen in FIG. 10 the present invention further comprises a method of providing a breath freshener 12 to a beverage container 16. The method comprises the steps of providing a container 16. An element 84 is provided which may be removably associated with the container 16 and an edible substance 86 is further which may be inserted into and retained by said element 84. The element 84 preferably comprises a paperboard sleeve 48 having one or more pouches 52 and 54 disposed thereon. The present invention further provides a system 88 for providing advertising graphics and print 90 and an edible breath freshening substance 92. The system includes a paperboard sleeve 48 sized constructed and arranged for reception of a paperboard cup 16. Advertising material 96 in the form of graphics and print may be printed on the sleeve and one or more tapered pouches 52 and 54 are provided on the sleeve 48 which contain an edible substance 86 for selective removable therefrom. In one embodiment the edible substance may have graphics printed thereon 98 including the logo of the advertiser.

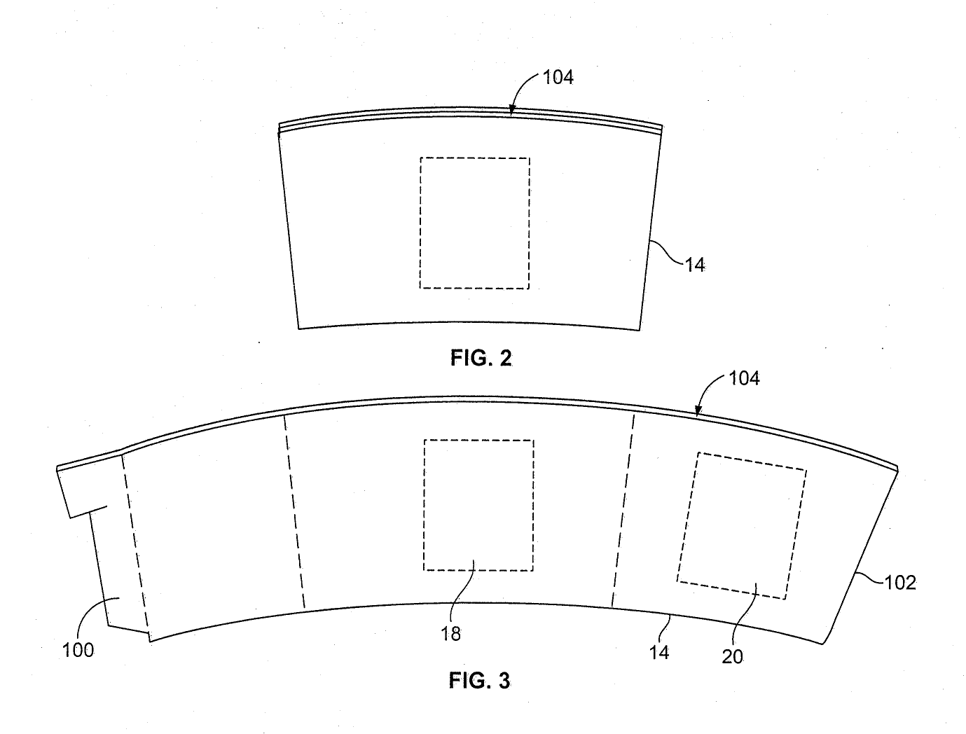

As seen in FIG. 3, in the preferred embodiment the paperboard sleeve 14 is curved and has one or more pouches 18 and 20 formed thereon. The curve of the sleeve is semicircular and has a first end 100 and second end 102 adapted for sealing attachment to each other so as to form a substantially conical sleeve 104 (FIG. 2) constructed and arranged for reception of a paperboard cup 1 (seen in FIG. 1). Alternate geometric configurations may also be used.

As best seen in FIG. 11 of the drawings, a system 200 is provided for supplying a beverage container 16 (FIG. 1) with a food supplement 12 (FIG. 13). Although the embodiment shown in FIG. 11 is rectangular in shape, it may be provided in a variety of geometric configurations. The system includes a patch 206 having pouches 208 and 210 affixed to the outer surface 212 of the patch. In a preferred embodiment the patch is 2½ inches wide by 1% inches high. Each individual pouch is 1¼ by 1 1/16 inches wide.

As seen in FIG. 13 of the drawings, in a preferred embodiment pouch 208 is tapered from its top 212 to its bottom 214. In the embodiment shown, which is a side view, pouch 208 has an opening 216 which is ½ inch in width and is 3/16 in width at the bottom 214. Pouch 208 as well as pouch 210 are expandable; they can be folded flat against patch 206 or they can be extended from front surface 212 to allow a food supplement 204 such as chewing gum, mint or candy to be inserted into pouches 208 and 210 respectively.

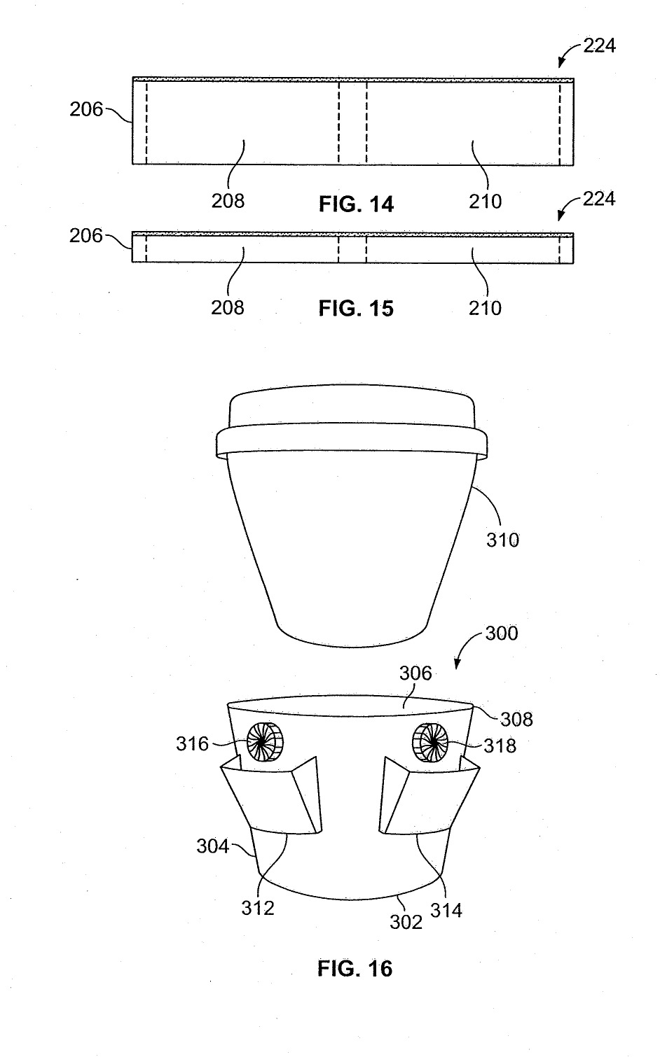

A top view of pouches 208 and 210 may be seen in FIG. 14 and a bottom view of pouches 208 and 210 may be seen in FIG. 15. Although two pouches are shown, in alternate embodiments a single pouch or plurality of pouches may be affixed to patch 206.

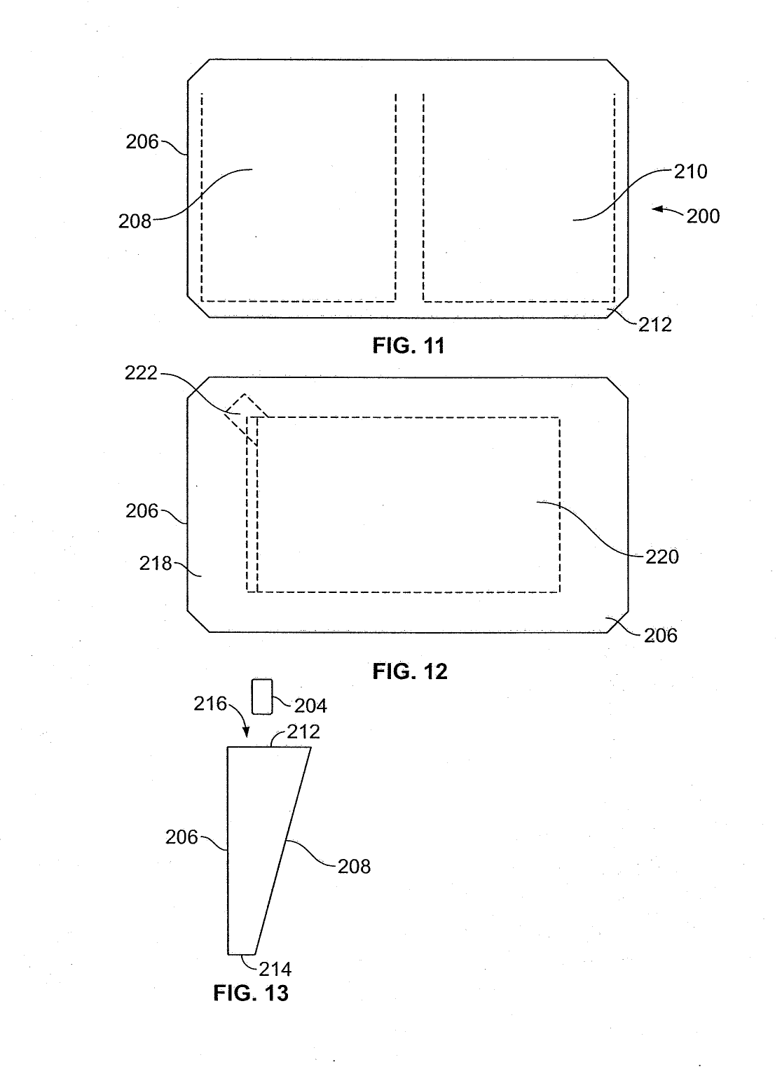

As best seen in FIG. 12, on the rear surface 218 of patch 206 a peel-away adhesive strip 220 is affixed to the patch 206. Peel-away strip adhesive strip 220 utilizes pressure sensitive adhesive affixed to the strip 220 which allows it to be peeled away from the back surface 218 of patch 206. Patch 206 may then be adhesively retained on container 16 (FIG. 1) for providing food supplements 204 in pouches 208 and 210. In a preferred embodiment peel-away adhesive strip is 1¾ inches wide by 1% inches in height. A tab 222 may be provided for peeling away peel-away adhesive strip 220 as required. Alternatively, as shown in FIG. 14, patch 206 may simply have a pressure sensitive adhesive 224 affixed to rear surface 218 of patch 206 and patch 206 simply applied to a container 16 as required. Although pressure sensitive adhesive is preferred, other forms of adhesive, such as hot melt or other FDA food grade approved adhesives may be utilized.

In another embodiment shown in FIG. 16, supplemental beverage container cup 300 is cylindrical in configuration having a bottom 302, sidewalls 304 and a circular opening 306 at the top 308 of the supplemental beverage container cup 300. Opening 306 and sidewalls 304 are sized, constructed and arranged for reception of and retention of beverage container 310 in supplemental beverage container cup 300. Further shown in FIG. 16 are pockets 312 and 314, sized constructed and arranged for reception of and retention of mints, candy, or gum, or as described and shown in FIGS. 1-7.

As mentioned previously, food supplement 316 may be chewing gum, mints, candy or other food products. They may be individually wrapped prior to insertion into pouches 18 and 20, 208 and 210, or 312 and 314. Patch 206 may be constructed of flexible paperboard, which may be rough or grainy and have a smooth or rough front. Alternatively, patch 206 may be constructed of flexible film such as high-density polyethylene, low density polyethylene, other polyolefins such as polypropylene, polyvinyl chloride, paper, or aluminum foil laminated to paper or plastic. Container 310 may be constructed of metal such as aluminum cans, plastics such as blow molded bottles, glass, as in wine bottles or beer and paperboard cups. Both patch 206 and sleeve 14 may be constructed of plastic such as PVC or polystyrene film. Also, they can be made of oriented polypropylene, oriented polystyrene or polyethylene terephthalate, which is typically 50 microns thick.

1. A system for dispensing breath fresheners comprising:
a paperboard sleeve adapted for reception of a paperboard cup;
one or more slotted, expandable, tapered pouches;
means for affixing the slotted, tapered, expandable pouches to the paperboard sleeve or beverage container.

2. The system of claim 1 wherein said tapered pouches are adhesively retained to said paperboard sleeve or beverage container.

3. The system of claim 1 wherein said tapered pouches are 1¼ inches plus or minus ¼ inch high by 3/16ths inches plus or minus 1/16th inch at their base and ½ inch plus or minus ⅛th inch at their top opening.

4. The system of claim 1 and further comprising one or more breath mints or chewing gum contained within said tapered, expandable pouches.

5. The system of claim 1 wherein there are two or more tapered, expandable pouches on said beverage sleeve.

6. The system of claim 1 wherein said beverage sleeve is constructed of corrugated paperboard having a thickness of 20 mils plus or minus 10 mils.

7. The system of claim 1 wherein said tapered, expandable pouches are constructed of paperboard having a thickness of 0.20+0.10 mils.

8. A cup and breath freshener combination device comprising;
a cup having a bottom and sidewalls, said sidewalls extending upwardly from said bottom and being sealed about the periphery of said bottom;
a sleeve circumferentially disposed around a portion of said sidewalls; and
one or more pouches affixed to said sleeve; and a breath freshener insertable in and retained by said pouches.

9. The disposable cup and breath freshener combination device of claim 8 wherein said pouches are tapered and expandable from said sidewalls of said cup.

10. The cup and breath freshener combination device of claim 8 wherein said breath freshener comprises a chewable food product sized for insertion into and retention in said pouches.

11. The cup and breath freshener combination device of claim 8 wherein said pouches are integrally formed in said sleeve.

12. The cup and breath freshener of claim 8 wherein said tapered pouches are 1¼ inches plus or minus ¼ inch high by 3/16ths inches plus or minus 1/16th inch at their base and ½ inch plus or minus ⅛th inch at their top opening.

13. The cup and breath freshener of claim 8 wherein said beverage sleeve is constructed of corrugated paperboard having a thickness of 20 mils plus or minus 5 mils.

14. The cup and breath freshener of claim 8 wherein said tapered, expandable pouches are constructed of paperboard having a thickness of 20 mils+10 mils.

15. A tapered substantially conical paperboard sleeve sized constructed and arranged for telescopic reception of a paperboard cup and retention thereon, said paperboard sleeve further having one or more tapered pouches affixed thereto, sized constructed and arranged for a reception of and retention of a breath freshening product.

16. The paperboard sleeve in claim 12 wherein said breath freshening product may be selected from the group consisting of mints, candy, or gum.

17. A method of providing a disposable cup and breath freshener combination comprising a disposable cup having a bottom, and sidewalls seemingly affixed to said bottom about the periphery of said bottom; and a paperboard sleeve size constructed and arranged for reception of said paperboard cup; said sleeve having one or more pouches sized constructed and arranged for reception of a breath freshener;
comprising the steps of inserting said breath freshener into said one or more pouches.

18. An apparatus for freshening breath after ingesting a beverage comprising;
a container having an upper end and lower end and sidewalls extending there between sealed to said lower end of said container; and
a breath freshener removable affixed to said container.

19. A method of providing a breath freshener to a beverage container comprising the steps of;
providing a container;
providing an element removably associated with said container; and
providing an edible substance which may be inserted into and retained by said element.

20. The method of claim 19 wherein said element comprises a paperboard sleeve having one or more pouches disposed thereon.

21. The paperboard sleeve of claim 24 wherein said sleeve is constructed of corrugated paperboard having the thickness of 20 mils plus or minus 5 mils.

22. The paperboard sleeve of claim 24 wherein said paperboard sleeve comprises expandable pouches constructed of paperboard having the thickness of 0.20 mils plus or minus 0.10 mils.

23. A system for providing advertising and an edible breath freshening substance comprising;
a paperboard sleeve sized constructed and arranged for reception of a paperboard cup;
advertising material printed on said sleeve;
one or more tapered pouches on said sleeve containing said edible substance for selective removal therefrom.

24. A paperboard sleeve comprising a curved portion of paperboard having one or more pouches formed thereon, said paperboard sleeve being semicircular and having a first end and a second end adapted for sealing attachment to each other so as to form a substantially conical sleeve sized constructed and arranged for reception of a paperboard cup, and one or more pockets for reception of and retention of food supplements.

25. The paperboard sleeve in claim 24 having a thickness of 0.20 mils plus or minus 0.10 mils.

26. The paperboard sleeve of claim 24 being constructed of solid bleach sulfate paper.

27. The paperboard sleeve of claim 24 being constructed of corrugated paper.

28. A system for dispensing breath fresheners comprising:
one or more slotted expandable paper pouches; and
means for affixing the slotted paper expandable pouches to a container.

29. A system for providing a breath freshener to a beverage container comprising:
a container;
an element removably associated with said container sized constructed and arranged for reception of an edible substance which may be inserted into and retained by said element.

30. The system of claim 29 wherein said element comprises a pouch which may be affixed to said container.

31. The system of claim 29 wherein said element comprises a patch which may be affixed to said container, said patch having one or more pouches operatively associated therewith for reception of and retention of a breath freshener.

32. The system of claim 31 wherein said patch is constructed from one of the materials comprising the group of paper, paperboard or plastic.

33. The system of claim 30 wherein said element is affixed to said container by means of an adhesive.

34. The system of claim 33 wherein said adhesive is a pressure sensitive adhesive.

35. A package for providing a breath freshener to a beverage container comprising:
a container;
an element affixable to said container sized constructed and arranged for reception of an edible substance which may be inserted into and retained by said element.

36. The package of claim 35 wherein said element comprises a patch which may be affixed to said container, said patch having one or more pouches operatively associated therewith for reception of and retention of a breath freshener.

37. The paperboard sleeve of claim 24 and further comprising a bottom on said paperboard sleeve for abutment against the bottom of said paperboard cup.

38. A sleeve comprising a curved portion having one or more pouches formed thereon, said sleeve being semicircular and having a first end and a second end adapted for sealing attachment to each other so as to form a substantially conical sleeve sized, constructed and arranged for reception of a beverage container, and one or more pockets for reception of and retention of food supplements.
the sleeve further comprising a bottom on said sleeve for abutment against the bottom of said beverage container.

39. A sleeve comprising a curved portion having one or more pouches formed thereon, said sleeve being semicircular and having a first end and a second end adapted for sealing attachment to each other so as to form a substantially conical sleeve, and a bottom sealed to said sleeve so as to form a supplemental beverage container, sized constructed and arranged for reception of a beverage container. said said supplemental beverage container having one or more pockets for reception of and retention of food supplements.

40. The tapered paperboard sleeve of claim 15 wherein said one or more pouches are integrally formed in said sleeve.

41. The paperboard sleeve of claim 24 wherein said food supplement may be selected from the group consisting of sugar, artificial sweetener, and creamer.

42. The package of claim 35 wherein said edible substance may be selected from the group consisting of sugar, artificial sweetener and creamer.

43. A paperboard sleeve comprising a curved portion of paperboard having one or more pouches formed thereon, said paperboard sleeve being semicircular and having a first end and a second end adapted for sealing attachment to each other so as to form a substantially conical sleeve, and two or more pockets for reception of and retention of food products.

44. A system for dispensing breath fresheners comprising:
one or more slotted expandable paper pouches; and
means for affixing the slotted paper expandable pouches to a container.

45. A system for providing a breath freshener to a container comprising:
a container;
an element removably associated with said container sized constructed and arranged for reception of an edible substance which may be inserted into and retained by said element.

46. The system of claim 45 wherein said element comprises a pouch which may be affixed to said container.

47. The system of claim 45 wherein said element comprises a patch which may be affixed to said container, said patch having one or more pouches operatively associated therewith for reception of and retention of a breath freshener.

48. A package for providing an edible substance to a container comprising:
a container;
an element affixable to said container sized constructed and arranged for reception of said edible substance which may be inserted into and retained by said element.

49. The package of claim 35 wherein said element comprises a patch which may be affixed to said container, said patch having one or more pouches operatively associated therewith for reception of and retention of said edible substance.

50. A sleeve comprising a curved portion having one or more pouches formed thereon, said sleeve being semicircular and having a first end and a second end adapted for sealing attachment to each other so as to form a substantially conical sleeve sized, constructed and arranged for reception of food, and one or more pockets for reception of and retention of food supplements.

51. A sleeve comprising a curved portion having one or more pouches formed thereon, said sleeve being semicircular and having a first end and a second end adapted for sealing attachment to each other so as to form a substantially conical sleeve, and a bottom sealed to said sleeve so as to form a food container, said food container having one or more pockets for reception of and retention of food supplements.

52. The tapered paperboard sleeve of claim 15 wherein said one or more pouches are integrally formed in said sleeve.
